(19) United States
(12) Patent Application Publication
(10) Pub. No.: US 2006/0229109 A1
(43) Pub. Date: Oct. 12, 2006

(54) Method and system for initiating communication from a vehicle

(75) Inventors: Christopher L. Oesterling, Troy, MI (US); Catherine L. McCormick, West Bloomfield, MI (US); Gary A. Watkins, Royal Oak, MI (US); Christine E. Meissner, Royal Oak, MI (US); Jeffrey M. Stefan, Clawson, MI (US)

Correspondence Address: General Motors Corporation;300 Renaissance Center, Mail Code 482-C23-B21, P.O. Box 300, Detroit, MI, 48265-3000, US

(73) Assignee: General Motors Corporation

(21) Appl. No.: 11/100,247

(22) Filed: Apr. 6, 2005

(51) Int. Cl. H04M 1/00

(52) U.S. Cl. 455/569.2; 455/427; 455/445; 455/456.1

(57) ABSTRACT

A method for mobile vehicle well-being notification including receiving a contact name from a user at a call center and receiving a contact method associated with the contact name from the user at the call center. The method further includes receiving a contact message associated with the contact name from a user at the call center and receiving a well-being notification from a user at a telematics unit. In response to the well-being notification, the method sends the contact message using the contact method to the contact name.

### FIELD OF THE INVENTION

The present invention generally relates to initiating communication between a mobile vehicle and a contact list.

### BACKGROUND OF THE INVENTION

In the event of a disaster, many telematic system users wish to contact a list of people who may be concerned about the user. However, communication may be difficult due to system overload from many people attempting communication at the same time, as well as system difficulties with degraded communication signals or facilities. Additionally, every potential person to be contacted may not have access to a particular technology to receive communications from the user.

The present invention overcomes these disadvantages and advances the state of the art in navigation systems.

### SUMMARY OF THE INVENTION

One aspect of the present invention provides a method for mobile vehicle well-being notification including receiving a contact name from a user at a call center and receiving a contact method associated with the contact name from the user at the call center. The method further includes receiving a contact message associated with the contact name from a user at the call center and receiving a well-being notification from a user at a telematics unit. In response to the well-being notification, the method sends the contact message using the contact method to the contact name.

Another aspect of the invention provides a computer readable medium including computer readable code for mobile vehicle well-being notification including computer readable code for receiving a contact name from a user at a call center and computer readable code for receiving a contact method associated with the contact name from the user at the call center. The medium further includes computer readable code for receiving a contact message associated with the contact name from a user at the call center and computer readable code for receiving a well-being notification from a user at a telematics unit. In response to the well-being notification, the code sends the contact message using the contact method to the contact name.

Another aspect of the invention provides a system for establishing communication with a mobile vehicle including means for mobile vehicle well-being notification including means for receiving a contact name from a user at a call center and means for receiving a contact method associated with the contact name from the user at the call center. The system further includes means for receiving a contact message associated with the contact name from a user at the call center and means for receiving a well-being notification from a user at a telematics unit. In response to the well-being notification, the system sends the contact message using the contact method to the contact name.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

FIG. 1 illustrates an operating environment for a method for mobile vehicle well-being notification;

FIG. 2 illustrates one embodiment of a method for mobile vehicle well-being notification in accordance with the instant invention;

FIG. 3 illustrates another embodiment of a method for mobile vehicle well-being notification in accordance with the instant invention;

FIG. 4 illustrates another embodiment of a method for mobile vehicle well-being notification in accordance with the instant invention; and

FIG. 5 illustrates another embodiment of a method for mobile vehicle well-being notification in accordance with the instant invention.

### DETAILED DESCRIPTION OF THE PREFERRED EMBODIMENTS

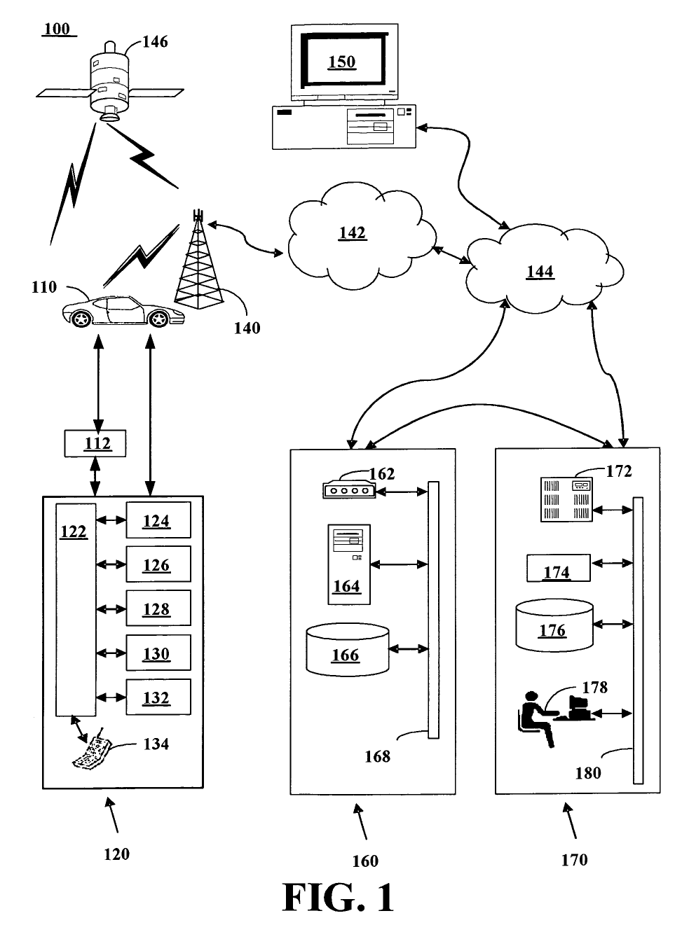

FIG. 1 illustrates an operating environment for a mobile vehicle communication system (“MVCS”) 100. MVCS 100 includes a mobile vehicle communication unit (“MVCU”) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, marine vehicle or as an aircraft. MVCU 110 may include additional components not relevant to the present discussion.

Vehicle communication network 112 sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Telematics unit 120 sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (“GPS”) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. Telematics unit 120 may include additional components not relevant to the present discussion. Telematics unit 120 is one example of a vehicle module.

In one embodiment, processor 122 is implemented as a microcontroller, controller, host processor, or vehicle communications processor. In one embodiment, processor 122 is a digital signal processor. In an example, processor 122 is implemented as an application specific integrated circuit. In another embodiment, processor 122 is implemented as a processor working in conjunction with a central processing unit performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode, or multi-band cellular phone.

Processor 122 executes various computer programs that control programming and operational modes of electronic and mechanical systems within MVCU 110. Processor 122 controls communication (e.g., call signals) between telematics unit 120, wireless carrier system 140, and call center 170. Additionally, processor 122 controls reception of communications from satellite broadcast system 146. In one embodiment, a voice-recognition application is installed in processor 122 that can translate human voice input through microphone 130 to digital signals. Processor 122 generates and accepts digital signals transmitted between telematics unit 120 and vehicle communication network 112 that is connected to various electronic modules in the vehicle. In one embodiment, these digital signals activate the programming mode and operation modes, as well as provide data transfers such as, for example, data over voice channel communication. In this embodiment, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band of 2.3 GHz that has been allocated by the U.S. Federal Communications Commission for nationwide broadcasting of satellite-based Digital Audio Radio Service.

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. In an example, processor 122 implements data packets received by telematics unit 120.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network. In another embodiment, land network 144 is implemented as an Internet Protocol (“IP”) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browsers and Internet-access computer programs for sending and receiving data over land network 144 and, optionally, wired or wireless communication networks 142 to web-hosting portal 160 through a web-page interface using communication standards such as hypertext transport protocol, and transport-control protocol and Internet protocol. In one embodiment, the data include directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data are stored at web-hosting portal 160.

Web-hosting portal 160 includes one or more data modems 162, one or more web-servers 164, one or more databases 166, and a network system 168. Web-hosting portal 160 is connected directly by wire to call center 170, or connected by phone lines to land network 144, which is connected to call center 170. In an example, web-hosting portal 160 connects to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that are then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web server 164 hosting portal 160 through a wireless communication network 142 and a land network 144. Data are received by land network 144 and sent to one or more web servers 164. In one embodiment, web server 164 is implemented as any suitable hardware and software capable of providing web server 164 services to help change and transmit personal preference settings from a client at computer 150 to telematics unit 120. Web server 164 sends to or receives from one or more databases 166 data transmissions via network system 168. Web server 164 includes computer applications and files for managing and storing personalized settings supplied by the client, such as door lock/unlock behavior, radio station preset selections, climate controls, custom button configurations, and theft alarm settings. For each client, the web server 164 potentially stores hundreds of preferences for wireless vehicle communication, networking, maintenance and diagnostic services for a mobile vehicle. In another embodiment, web server 164 further includes data for managing turn-by-turn navigational instructions.

In one embodiment, one or more web servers 164 are networked via network system 168 to distribute user-preference data among its network components such as databases 166. In an example, database 166 is a part of or a separate computer from web server 164. Web server 164 sends data transmission with user preferences to call center 170 through land network 144.

Call center 170 is a location where many calls are received and serviced at the same time, or where many calls are sent at the same time. In one embodiment, the call center is a telematics call center facilitating communications to and from telematics unit 120. In another embodiment, the call center is a voice call center, providing verbal communications between an advisor in the call center and a subscriber in a mobile vehicle. In yet another embodiment, the call center contains each of these functions. In other embodiments, call center 170 and web server 164 and hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web server 164 and hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmission via network system 180. In one embodiment, communication services manager 174 includes at least one analog and/or digital modem.

Communication services manager 174 sends to or receives from one or more communication services advisors 178 data transmission via network system 180. Communication services database 176 sends or receives from communication services advisor 178 data transmissions via network system 180. Communication services advisor 178 receives from or sends to switch 172 voice or data transmissions. Communication services manager 174 provides one or more of a variety of services including initiating data over voice channel wireless communication, enrollment services, navigation assistance, directory assistance, roadside assistance, business or residential assistance, information services assistance, emergency assistance, and communications assistance.

Communication services manager 174 receives service-preference requests for a variety of services from the client computer 150, web server 164, hosting portal 160, and land network 144. Communication services manager 174 transmits user-preference and other data such as, for example, primary diagnostic script to telematics unit 120 through wireless carrier system 140, communication network 142, land network 144, voice and data switch 172, and network system 180. Communication services manager 174 stores or retrieves data and information from communication services database 176. Communication services manager 174 may provide requested information to communication services advisor 178. In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to a telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140, and satellite broadcast system 146. In this embodiment, an inbound communication is routed to call center 170 from telematics unit 120 via wireless carrier system 140, communication network 142, and land network 144.

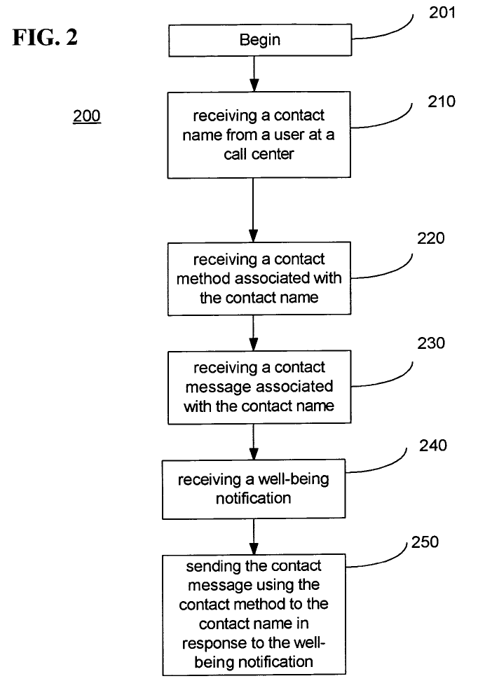

FIG. 2 illustrates one embodiment of a method 200 for mobile vehicle well-being notification in accordance with the instant invention. Method 200 begins at 201.

A contact name is received from a user at a call center at step 210. The contact name may be received using any appropriate data entry technique, including using a web interface, using packet data transmissions, email, submission of a written form, oral instructions using a telephone or wireless connection with an advisor, facsimile transmissions, short message interface, text messaging, instant messaging or the like. The contact name includes an identifier sufficient to convey the identification of a desired recipient of a message.

In one embodiment, the contact name includes at least one contact address indicating an address at which the contact name is to be contacted. For example, a contact name “MOM” conveys that the contact is named “Mom” and includes a phone number “(555) 555-1212” at which Mom is to be contacted. In another example, contact name “BOB” indicates that Bob is the contact, and includes a contact address “bob bob.com” at which Bob is to be emailed. A contact name, in one embodiment, is associated with multiple contact addresses so that a contact name is contacted at multiple locations. The contact address, in various embodiments, includes email addresses, phone numbers, pager numbers, facsimile numbers, IP addresses, screen names, pager numbers, web addresses, etc.

The call center receives a contact method associated with the contact name from the user at step 220. The contact method may be any appropriate method for initiating communication, including but not limited to, phone call, email, short message, text message, instant message, facsimile transmission and pager. A contact name, in one embodiment, is associated with multiple contact methods so that a contact name is contacted using multiple techniques. In another embodiment, the contact method is a web interface, such as a bulletin board or status posting on a website. In one embodiment, the website is password protected. In yet another embodiment, the contact method is a voicemail exchange configured for access by a concerned party other than the user. In yet another embodiment, the contact method is a voicemail exchange configured for exchange of well-being notifications between a user and at least one concerned party.

The call center receives a contact message associated with the contact name from the user at step 230. In one embodiment, a contact message may be associated with multiple contact names. Thus, for example, a contact message of “I'M OKAY” may be sent via email to “MOM”, “DAD”, and “BOB”. A contact message may be a text string, a graphical image, or a sound recording, or other suitable communication.

A well-being notification is received at a telematics unit at step 240. In one embodiment, the telematics unit is implemented as telematics unit 120 as described in FIG. 1. The well-being notification can be received using a data input, such as a button push or an oral instruction. As used herein, a “well-being” notification is a notification that the user, i.e. the person issuing the well-being notification, has a generally good well-being, and is “okay” despite events surrounding their geographic disposition.

In one embodiment, the well-being notification is received in response to a status request issued by the call center requesting that a user provide an update as to their condition. Thus, for example, a user may provide a well-being notification directly to the telematics unit. In another example, the user provides the well-being notification in response to a request from the call center. In one embodiment, a concerned party, other than the user, contacts the call center to request a status update for a user, and in response to the status request, the call center polls the telematics unit using a wireless network to request a well-being notification.

For example, a national authority declares a disaster in Cook County, Ill. in response to a tornado warning. Concerned parties (such as family, coworkers, friends, etc.) contact a central location, such as call center 170, to request a status update from loved ones who reside in Cook County. The concerned parties may contact the call center on a dedicated line assigned to each user, on a general status request line, via a web interface, or by any other communication method appropriate for the situation. In response to the contact from the concerned parties, call center 170 issues a status request, via a wireless network or a satellite radio subcarrier, to a mobile vehicle associated with the loved one to request that the user provide a well-being notification. In the event that the telematics unit 120 receives the status request, the user is prompted to reply to provide a status update that the user is fine, or that the user requires assistance.

In response to the well-being notification, the contact message is sent to the contact name using the contact method at step 250. For example, in response to the well-being notification, the contact message “I'M OKAY” is sent to “MOM” using a phone call to (555) 555-1212. In one embodiment, the contact message is sent from the call center, while in another embodiment, the contact message is sent from the telematics unit. Embodiments where the contact message is sent from the telematics unit may require initiation of multiple communication sessions from a vehicle in an area undergoing compromised communication ability due to system overload or signal degradation due to inclement weather or conditions. Method 200 ends at step 260.

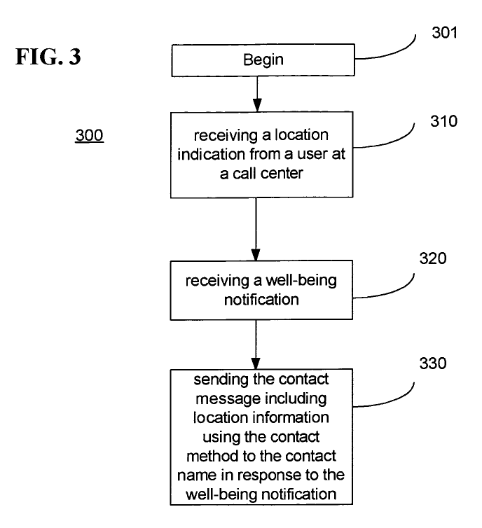

FIG. 3 illustrates one embodiment of a method for mobile vehicle well-being notification in accordance with one aspect of the invention. Method 300 begins at 301. Method 300 includes the steps of method 200 and further includes receiving a location indication from the user at the call center at step 310. The location indication indicates whether the associated user is permitted to receive the user's geophysical location in the event of a well-being notification. In embodiments that include a location indication, sending the contact message includes determining a geophysical location, and sending the geophysical location with the contact message to the contact name using the contact method at step 330 in response to receiving a well-being notification at step 320. Geophysical location may be determined using any appropriate technique, including polling a GPS unit, such as GPS unit 126. Dead reckoning navigational techniques are used, in one embodiment, in the event of GPS interruptions. In one embodiment, each contact name receives the location information, while in other embodiments, only those contacts associated with affirmative location information are provided the location information.

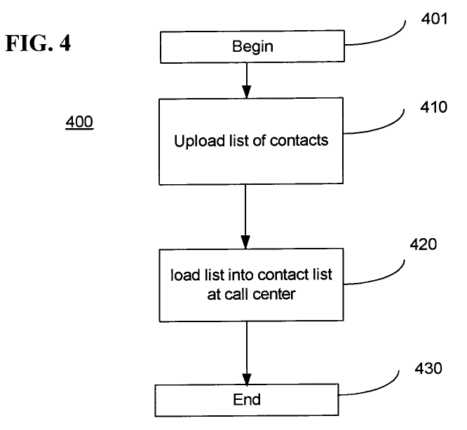

FIG. 4 illustrates one embodiment of a method 400 for receiving a contact list at a call center in accordance with one aspect of the invention. Method 400 begins at 401.

A user uploads a list of contacts at step 410. The list of contacts includes contact information, such as contact name, contact address, and contact method. In one embodiment, the contact list further includes a contact message.

The contact list is loaded into a contact list at the call center, and becomes a portion of a contact database maintained by the call center, at step 420. Method 400 ends at step 430.

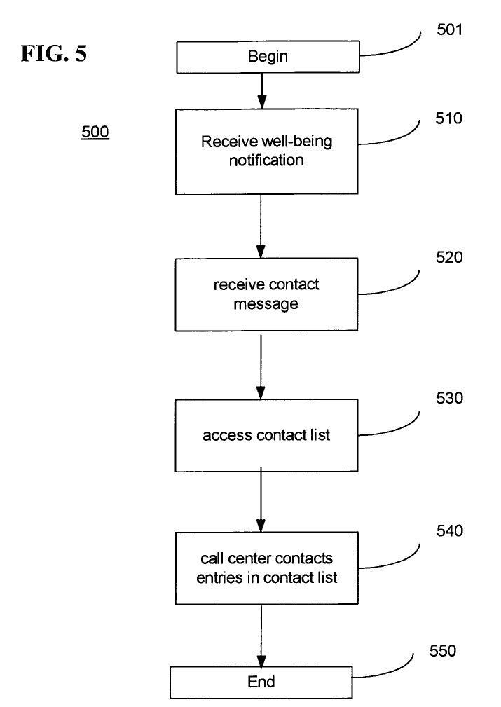

FIG. 5 illustrates one embodiment of a method 500 for contacting a contact list, in accordance with one aspect of the invention. Method 500 begins at 501.

A well-being notification is received at step 510. The well-being notification is received, for example, as a result of a button push.

A contact message is received at the call center at step 520. For example, a contact message “I'M OKAY” is enunciated into a microphone in communication with the telematics unit in response to the well-being notification, and the contact message is communicated to the call center via a wireless connection. In one embodiment, the contact message is stored in the communication services database 166.

The contact list is accessed at step 530, and the call center contacts each entry on the contact list at step 540. In one embodiment, the contact list is stored in and retrieved from the communication services database 166. Method 500 ends at step 550.

The present invention may be embodied in other specific forms without departing from the spirit or essential characteristics. The described embodiments are to be considered in all respects only as illustrative and not restrictive.

What is claimed is:

1. A method for mobile vehicle well-being notification, the method comprising:
receiving a contact name from a user at a call center;
receiving a contact method associated with the contact name from the user at the call center;
receiving a contact message associated with the contact name from a user at the call center;
receiving a well-being notification at a telematics unit;
sending the contact message using the contact method to the contact name in response to the well-being notification.

2. The method of claim 1, wherein the contact method is selected from the group consisting of phone call, email, website, short message, text message, instant message, facsimile transmission, voicemail exchange, and pager.

3. The method of claim 1 further comprising receiving a location indication from the user at the call center, and wherein sending the contact message includes sending a location indication to at lease one contact name in response to the location indication.

4. The method of claim 3, wherein sending the contact message comprises determining a geophysical location.

5. The method of claim 1, wherein the well-being notification is received from a user input.

6. The method of claim 1, wherein the contact name includes at least one contact address.

7. The method of claim 6, wherein the contact address comprises at least one of the group consisting of email address, website address, IP address, phone number, pager number, facsimile number, and screen name.

8. The method of claim 1 wherein the contact message is sent from a call center in response to a request from the telematics unit.

9. The method of claim 1 wherein the contact message is sent via a wireless network from the telematics unit.

10. The method of claim 1 wherein the well-being notification is received in response to a status request issued by the call center.

11. A computer usable medium including computer readable code for mobile vehicle disaster communication, the code comprising:
computer readable code for receiving a contact name from a user at a call center;
computer readable code for receiving a contact method associated with the contact name from the user at the call center;
computer readable code for receiving a contact message associated with the contact name from a user at the call center;
computer readable code for receiving a well-being notification from a user at a telematics unit;
computer readable code for sending the contact message using the contact method to the contact name in response to the well-being notification.

12. The computer usable medium of claim 11, wherein the contact method is selected from the group consisting of phone call, email, short message, text message, website, instant message, facsimile transmission, voicemail exchange, and pager.

13. The computer usable medium of claim 12, further comprising computer readable code for receiving a location indication from the user at the call center, and wherein code for sending the contact message includes code for sending a location indication to at lease one contact name in response to the location indication.

14. The computer usable medium of claim 11, wherein sending the contact message comprises determining a geophysical location.

15. The computer usable medium of claim 11, wherein the well-being notification is received from a user input.

16. The computer usable medium of claim 11, wherein the contact name includes at least one contact address.

17. The computer usable medium of claim 16. wherein the contact address comprises at least one of the group consisting of email address, phone number and screen name.

18. The computer usable medium of claim 11, wherein the contact message is sent via a wireless network from the telematics unit

19. The computer usable medium of claim 11, wherein the contact message is sent from the call center.

20. A system for mobile vehicle disaster communication, the system comprising:
means for receiving a contact name from a user at a call center;
means for receiving a contact method associated with the contact name from the user at the call center;
means for receiving a contact message associated with the contact name from a user at the call center;
means for receiving a well-being notification from a user at a telematics unit;
means for sending the contact message using the contact method to the contact name in response to the well-being notification.
